(19) United States
(12) Patent Application Publication
(10) Pub. No.: US 2002/0112672 A1
(43) Pub. Date: Aug. 22, 2002

(54) Restriction of movement of small animals in conic bags to perform ultrasound and other exanimations in conscious and semiconscious animal

(76) Inventor: Ingeborg Schafhalter, San Bruno, CA (US)

Correspondence Address: Ingeborg Schafhalter, 2485 Trenton Drive, San Bruno, CA, 94066, US

(21) Appl. No.: 10/059,490

(22) Filed: Jan. 31, 2002

Related U.S. Application Data
(60) Provisional application No. 60/261,342, filed on Jan. 13, 2001.

(51) Int. Cl. A01K 1/03

(52) U.S. Cl. 119/417

(57) ABSTRACT

This invention is a method that makes it easy for scientists and veterinarians to perform ultrasound examinations on small animals without anesthetizing them or grapping them on the neck. New is the use of a transparent conic plastic back to restrict the animal. The examination is performed through the plastic by a special way of placing the ultrasound gel.

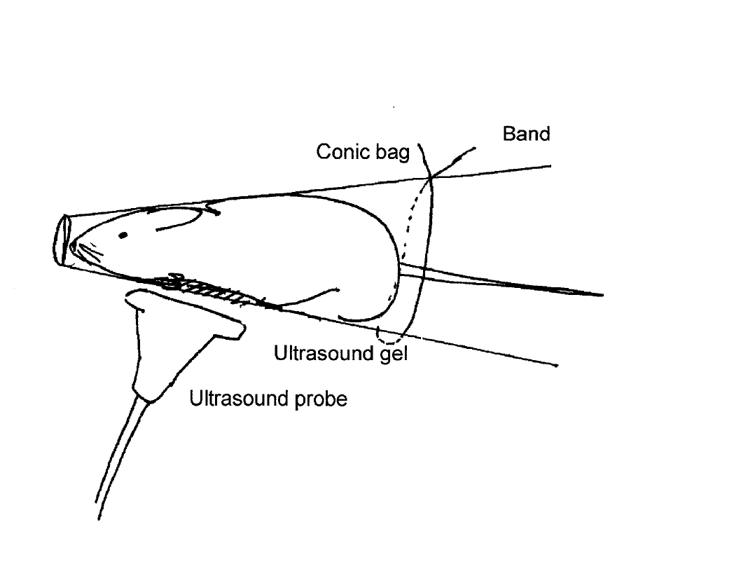

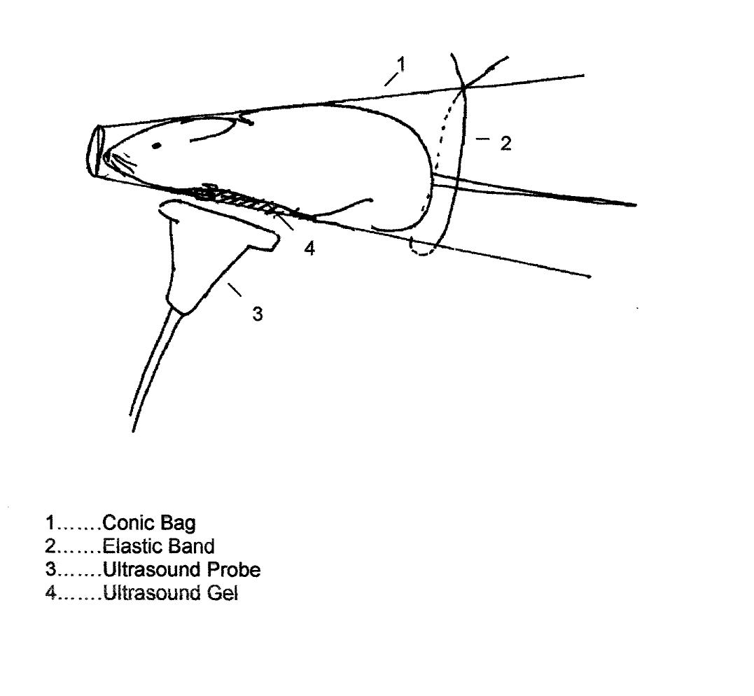

Restriction of movement of small animals in conic plastic bag to perform ultrasound and other examinations in conscious and semiconscious animal.

### BACKGROUND OF THE INVENTION

Ultrasound examinations and especially echocardiography are an emerging field in today's research ^{1, 2}. The creation of more and more transgenic animals and the invention of more sophisticated animal models need easy techniques for in vivo examination of the body function of these animals. ¹Tanaka N, Dalton N, Mao L, Rockman H A, Peterson K L, Gottshall K R, Hunter J J, Chien K R, Ross J Jr. Transthoracic echocardiography in models of cardiac disease in the mouse. Circulation. Sep. 1, 1996; 94(5): 1109-17 ²Gao X M, Dart A M, Dewar E, Jennings G, Du X J. Related Articles Serial echocardiographic assessment of left ventricular dimensions and function after myocardial infarction in mice. Cardiovasc Res. Jan. 14, 2000; 45(2): 330-8

Ultrasound examinations of animals for scientific research, veterinarian and other applications are done so far under anesthesia or by grapping the animal directly on the neck. The problem of anesthesia is its acute and chronic influence on body function. Anesthetics affect results and endanger or kill severely sick animals. The examiner has to wait until the anesthetics work und take special care of the anesthetized animal. Performing ultrasound examinations by grapping the animals causes stress for the animals, dangerous handling for the examiner and usually needs several days training of the animals³. Both traditional methods are performed while the animal lies on its back or on its side, both non-physiological positions. ³Yang X P, Liu Y H, Rhaleb N E, Kurihara N, Kim H E, Carretero O A. Echocardiographic assessment of cardiac function in conscious and anesthetized mice. Am J Physiol. November 1999; 277(5 Pt 2): H1967-74

### BRIEF SUMMARY OF THE INVENTION

The object of this invention is to provide a physiological, easy and fast applicable and safe method to perform ultrasound examinations in small animals.

The described new method allows examinations of animals by physical restriction of movement in conic plastic bags without using anesthesia. Experiments show that this method causes negligible stress by mimicking the animals' natural behavior. Small animals prefer to snuggle in small spaces. This method is immediately applicable on small animals without training. Examinations can be repeated multiple times without any delay and do not endanger sick and weaker animals.

The advantages of this method are physiological correct results and an easy and safe handling for the examiner. This method allows the animal to sit in a physiological position (on its stomach). For example, it allows drug infusion in the animal and simultaneous examination of the heart without interference with anesthetics.

### BRIEF DESCRIPTION OF THE SEVERAL VIEWS OF THE DRAWING

Drawing 1: The drawing shows how the animal is positioned in the conic bag and how an ultrasound probe may be placed on the animal.

### DETAILED DESCRIPTION OF THE INTERVENTION

In this method the animal is placed in a conic transparent plastic bag of a size according to the animal's body size with a small opening for breathing (size for rats approximately: small diameter: 1 cm, big diameter: 10 cm; size for mice approximately: small diameter: 0.75 cm, big diameter: 3.5). The animal sits in this bag with its head to the tip of the cone. The wide side is closed with a band or wrapped by hand to restrict the animal in the bag.

For ultrasound examinations ultrasound gel is placed through a little hole on the inner side of the bag between animal and bag and on the outer side of the bag. The gel application on the outer side is not mandatory but improves the image quality. Because of this way of placing the gel the ultrasound examination can be performed through the plastic bag.

The animal can be held in different positions (e.g.: lying on its back, sitting on its stomach).

Compared to the ultrasound examination under anesthetics no drugs are used.

Compared to the grapping method the examiner does not touch the animal directly.

Compared to both methods sitting in the bag allows the animal a minimum on movement so that it may place itself comfortably.

What I claim as my invention is:

1. The use of conic bag to restrain small animals for treatment and examination.

2. The use of conic plastic bag to restrain rodents for investigating the animals' physiology and pathophysiology with invasive and noninvasive examination devices.

3. The use of conic no opaque plastic bag to restrain mice, rats, hamsters and guinea pigs to perform invasive and noninvasive examinations of the conscious and semiconscious animals with ultrasound, catheters, blood pressure apparatus, oxygen saturation measurement devices and other invasive and noninvasive examination devices.
